(19) United States
(12) Patent Application Publication
(10) Pub. No.: US 2024/0319218 A1
(43) Pub. Date: Sep. 26, 2024

(54) INTELLIGENT INTEGRATED EQUIPMENT FOR A WHOLE PROCESS OF QUALITY INSPECTION AND TESTING OF ALUMINUM ALLOY AND ALUMINUM INGOTS

(71) Applicant: Guiyang Aluminum Magnesium Design & Research Institute Co., Ltd., Guiyang (CN)

(72) Inventors: Hui LU, Guiyang (CN); Feiya YAN, Guiyang (CN); Liang MA, Guiyang (CN); Jun LIU, Guiyang (CN); Wenjie REN, Guiyang (CN); Daigui MO, Guiyang (CN); Yu AO, Guiyang (CN)

(73) Assignee: Guiyang Aluminum Magnesium Design & Research Institute Co., Ltd., Guiyang (CN)

(21) Appl. No.: 18/235,736

(22) Filed: Aug. 18, 2023

(30) Foreign Application Priority Data
Mar. 20, 2023 (CN) 2023102723894

(51) Int. Cl. G01N 35/04; B25J 9/16; B65G 1/137; G01N 35/00

(52) U.S. Cl. CPC G01N 35/04; B25J 9/1612; B25J 9/1697; B65G 1/1373; G01N 35/0099; G01N 2035/0479

(57) ABSTRACT

An intelligent integrated equipment for a whole process of quality inspection and testing of aluminum alloy and aluminum ingots is provided, relating to the technical field of metal sample testing and quality inspection automation and informationization integration. A pneumatic sample conveying system pneumatically conveys samples. An automatic sample preparation system turn-mills the samples according to a sample preparation instruction of an integrated control center. An automatic sample detection system detects the elemental composition of the turn-milled samples according to a detection instruction of the integrated control center, and transports the detected samples to a sample filing and warehousing system. A detection result can be displayed on a display device. The whole-process intelligent quality inspection and testing of aluminum alloy and aluminum ingots is enabled.

### CROSS-REFERENCE TO RELATED APPLICATION

This patent application claims the benefit of and priority to Chinese Patent Application No. 2023102723894 filed with the China National Intellectual Property Administration on Mar. 20, 2023, the disclosure of which is incorporated by reference herein in its entirety as part of the present application.

### TECHNICAL FIELD

The present disclosure relates to the technical field of integration of automation and informatization for metal sample testing and quality inspection, in particular to an intelligent integrated equipment for a whole process of quality inspection and testing of aluminum alloy and aluminum ingots.

### BACKGROUND

In the field of nonferrous metal smelting, the metallurgical endpoint process control and product quality control are very important for the production process. For the production process of aluminum alloy and aluminum ingots, it is of significance to quickly, accurately and conveniently measure the chemical composition of melt in the mixing furnace or holding furnace in fusion casting and casting processes, for control of the quality of alloy and aluminum ingot products and reduction of the energy consumption and labor intensity. Moreover, the intellectualization development of quality inspection, testing and measurement control in aluminum smelting is also an important part of the transformation, upgrading and high-quality development of aluminum industry.

At present, the quality inspection and testing operation of aluminum alloy and aluminum ingots in electrolytic aluminum production process is heavy in workload, high in operation frequency, strong in timeliness requirements and serious in occupational health hazards. The quality inspection and testing operation of aluminum alloy and aluminum ingots mainly includes sampling, sample delivery, sample preparation, detection and filing, etc. . . . The sampling operation of aluminum alloy and aluminum ingots is mainly manually completed by sampling tools and sampling molds, and the sample temperature is high. The aluminum alloy and aluminum ingots taken out are sent manually, resulting in a large amount of samples to be sent in total, however with a small amount of samples sent each time, and the frequency is high. The information such as sample delivery batches needs to be recorded and registered, so that the labor intensity is high, and the degree of informationization is low. The samples delivered to the quality inspection center are tum-milled, which relies on manual labor, turn-milling out end faces of samples whose cleanliness and roughness meet the requirements demanded for spark direct-reading spectrum monitoring and analysis. In the process, the labor intensity is high, and the potential safety hazards are serious. The prepared samples are detected and analyzed manually by a spark direct-reading spectrum single piece detection and analysis. The process is high in labor intensity, serious in occupational health hazards caused by ionizing radiation and easy to make mistakes in manual operation. The quality inspection results are mostly fed back to the furnace man or the quality control department through the enterprise WeChat group or paper report, resulting in low timeliness.

In conclusion, the quality inspection and testing process of aluminum alloy and aluminum ingots has some problems, such as poor connection of various procedures, scattered physical space layout, low degree of automation, high labor intensity, serious occupational health hazards. high risk of potential safety hazards, lag in results feedback, low degree of informationization and low degree of intelligence.

### SUMMARY

The purpose of the present disclosure is to provide an intelligent integrated equipment for a whole process of quality inspection and testing of aluminum alloy and aluminum ingots so as to realize the intelligentization, systematization and integration of quality inspection and testing in aluminum industry.

In order to achieve the purpose, the present disclosure provides the following solutions.

An intelligent integrated equipment for a whole process of quality inspection and testing of aluminum alloy and aluminum ingots includes a pneumatic sample conveying system, an automatic sample preparation system, an automatic sample detection system, a sample filing and warehousing system, an integrated control center, a display device and a data fusion system;

where the integrated control center may respectively connect with the automatic sample preparation system, the automatic sample detection system and the display device; the data fusion system is respectively connected with the pneumatic sample conveying system, the automatic sample preparation system, the automatic sample detection system and the sample filing and warehousing system;

the pneumatic sample conveying system may be configured for pneumatically conveying samples taken out from a mixing furnace or a holding fumace to the automatic sample preparation system;

the automatic sample preparation system may be configured for turn-milling the samples according to a sample preparation instruction of the integrated control center, and conveying the turn-milled samples to the automatic sample detection system; the turn-milled samples are aluminum alloy or aluminum ingots to be detected;

the automatic sample detection system may be configured for detecting element composition of the turn-milled samples according to a detection instruction of the integrated control center, sending a detection result to the integrated control center, and conveying the detected samples to the sample filing and warehousing system for filing and warehousing;

the integrated control center may be configured for sending the detection result to the display device for display;

the data fusion system may be configured for collecting sampling information, sample delivery information of the pneumatic sample conveying system, preparation information of the automatic sample preparation system, detection information of the automatic sample detection system and warehousing information of the sample filing and warehousing system; and obtaining a proportioning adjustment scheme according to the sampling information, the sample delivery information, the preparation information, the detection information and warehousing information, by using an aluminum alloy proportioning model and an aluminum ingot proportioning model, and analyzing the product quality by using a composition quality analysis control model.

According to the specific embodiments provided by the present disclosure, the present disclosure discloses the following technical effects.

Disclosed is an intelligent integrated equipment for a whole process of quality inspection and testing of aluminum alloy and aluminum ingots. The pneumatic sample conveying system pneumatically conveys the samples taken out from the mixing furnace or holding furnace. The automatic sample preparation system turn-mills the samples according to a sample preparation instruction from the integrated control center. The automatic sample detection system detects the elemental composition of the turn-milled samples according to a detection instruction from the integrated control center, and sends the detection result to the integrated control center, and conveys the detected samples to the sample filing and warehousing system for filing and warehousing. The detection result can be displayed on the display device. Thus full-automation of sample delivery, sample preparation, detection and filing and warehousing operations of the aluminum alloy and aluminum ingots metal samples is realized. Through an integrated arrangement, the quality inspection and testing of aluminum alloy and aluminum ingots with the whole-process intelligentized can be completed quickly and conveniently. According to the sampling information, sample delivery information, preparation information, detection information and warehousing information, the data fusion system obtains a proportioning adjustment scheme by using an aluminum alloy proportioning model and an aluminum ingot proportioning model, and analyzes the sample quality by using a composition quality analysis control model, so as to improve the quality and efficiency of quality inspection and testing and enhance the intelligent management and control level of quality inspection and testing.

### BRIEF DESCRIPTION OF THE DRAWINGS

To describe the technical scheme in the embodiments of the present disclosure or in the prior art more clearly, the following briefly introduces the attached figures required for describing the embodiments. Apparently, the attached figures in the following description show merely some embodiments of the present disclosure, and those skilled in the art may still derive other attached figures from these attached figures without creative efforts.

FIG. 1 is a system configuration diagram of the intelligent integrated equipment for a whole process of quality inspection and testing of aluminum alloy and aluminum ingots in the present disclosure;

FIG. 2 is a process flow diagram of the intelligent integrated equipment for a whole process of quality inspection and testing of aluminum alloy and aluminum ingots in the present disclosure;

FIG. 3 is an Internet-of-things topological graph of the intelligent integrated equipment for a whole process of quality inspection and testing of aluminum alloy and aluminum ingots in the present disclosure;

FIG. 4 is a system architecture diagram of the intelligent integrated equipment for a whole process of quality inspection and testing of aluminum alloy and aluminum ingots in the present disclosure;

FIG. 5 is a data information fusion diagram of the present disclosure;

FIG. 6 is a control schematic diagram of the present disclosure;

FIG. 7 is a schematic diagram of a sampling mold device in the present disclosure;

FIG. 8 is a schematic diagram of a sample conveying bin in the present disclosure;

FIG. 9 is a schematic diagram of an automatic sample bin opening and closing device in the present disclosure;

FIG. 10 is a schematic diagram of a vibration straightening device in the present disclosure;

FIG. 11 is a schematic diagram of a sample tray in the present disclosure;

FIG. 12 is a schematic diagram of a robot gripper in the present disclosure; and

FIG. 13 is a schematic diagram of sample identity information identification, a spark stand surface and an internal electrode cleaning device in the present disclosure.

### DETAILED DESCRIPTION OF THE EMBODIMENTS

The following clearly and completely describes the technical scheme in the embodiments of the present disclosure with reference to the attached figures in the embodiments of the present disclosure. Apparently, the described embodiments are merely a part rather than all of the embodiments of the present disclosure. All other embodiments obtained by those with ordinary skill in the art based on the embodiment in the present disclosure without creative labor belong to the scope protected by the present disclosure.

To make the foregoing objective, features and advantages of the present disclosure clearer and more comprehensible, the present disclosure is further described in detail below with reference to the attached figures and specific embodiments.

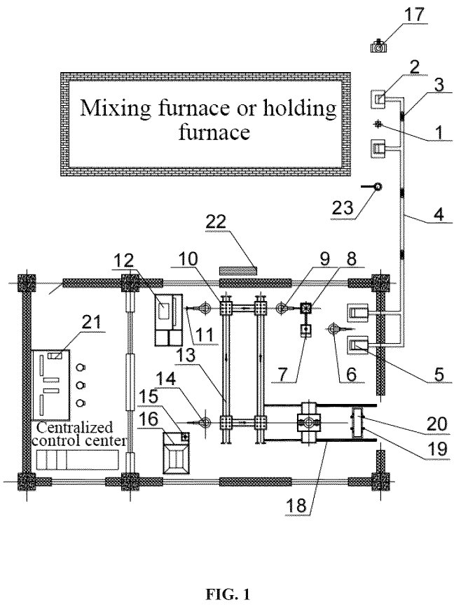

It is provided an intelligent integrated equipment for a whole process of quality inspection and testing of aluminum alloy and aluminum ingots according to embodiments of the disclosure. As shown in FIG. 1, the integrated equipment includes a pneumatic sample conveying system, an automatic sample preparation system, an automatic sample detection system, a sample filing and warehousing system, an integrated control center, a display device and a data fusion system.

The integrated control center is respectively connected with the automatic sample preparation system, the automatic sample detection system and the display device. The data fusion system is respectively connected with the pneumatic sample conveying system, the automatic sample preparation system, the automatic sample detection system and the sample filing and warehousing system.

The pneumatic sample conveying system is configured for pneumatically conveying samples taken out from a mixing furnace or a holding furnace to the automatic sample preparation system. The automatic sample preparation system is configured for turn-milling the samples according to a sample preparation instruction from the integrated control center, and conveying the turn-milled samples to the automatic sample detection system. The turn-milled samples are aluminum alloy or aluminum ingots to be detected. The automatic sample detection system is configured for detecting the element composition of the turn-milled samples according to a detection instruction from the integrated control center, sending a detection result to the integrated control center, and conveying the detected samples to the sample filing and warehousing system for filing and warehousing. The integrated control center is configured for sending the detection result to the display device for display. The data fusion system is configured for collecting sampling information, sample delivery information of the pneumatic sample conveying system, preparation information of the automatic sample preparation system, detection information of the automatic sample detection system and the warehousing information of the sample filing and warehousing system, obtaining a proportioning adjustment scheme according to the sampling information, the sample delivery information, the preparation information, the detection information and the warehousing information by using an aluminum alloy proportioning model and an aluminum ingot proportioning model, and analyzing the product quality by using a composition quality analysis control model.

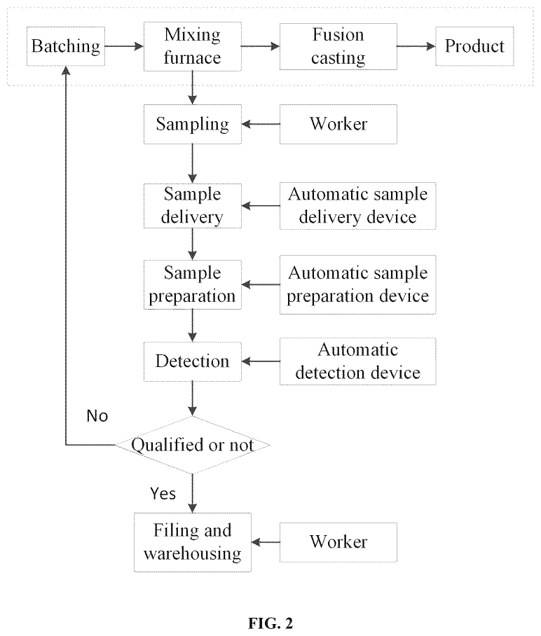

Referring to FIG. 2, the intelligent integrated equipment for a whole process of quality inspection and testing of aluminum alloy and aluminum ingots involves the entire process of sampling, sample delivery, sample preparation, detection, filing and warehousing of samples, realizing whole-process intelligentized quality inspection and testing, except for several procedures requiring manual assistance.

The following is to provide a detail description to each procedure with reference to the flow shown in FIG. 2.

### (1) Sampling

In an example, the intelligent integrated equipment for a whole process of quality inspection and testing of aluminum alloy and aluminum ingots further includes a sampling mold 23, a pneumatic quick chilling device I and a sample marking device 17. The sampling mold 23 is configured for taking out molten alloy samples or molten metal samples in the mixing furnace or the holding furnace according to a sampling instruction from the integrated control center. The pneumatic quick chilling device 1 is configured for chilling the molten alloy samples or molten metal samples. The sample marking device 17 is configured for marking the identity properties of the chilled samples.

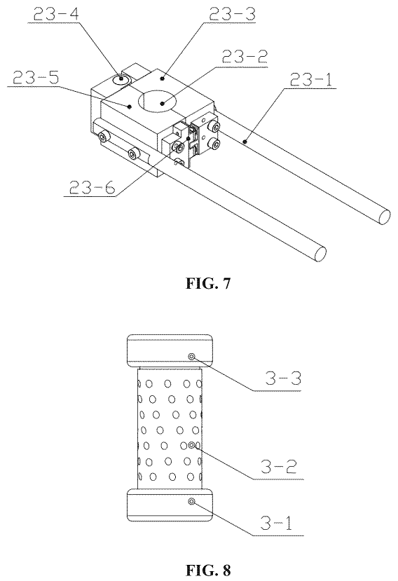

FIG. 7 illustrates a specific structure of the sampling mold 23. The sampling mold 23 includes a left mold 23-5, a right mold 23-3, a hinge 23-4, a lock catch 23-6 and two handrails 23-1. One end of the left mold 23-5 and one end of the right mold 23-3 are connected through the hinge 23-4, and the other end of the left mold 23-5 and the other end of the right mold 23-3 are connected through the lock catch 23-6. The left mold 23-5 and the right mold 23-3 are arranged with semicircular grooves in respective sides connecting to each other, and the two semicircular grooves form a circular cavity 23-2. A handrail 23-1 is arranged on the other side of the left mold 23-5 and a handrail 23-1 is arranged on the other side of the right mold 23-3, respectively. When clamping samples from the mixing furnace or holding furnace, the lock catch 23-6 is opened through the handrails 23-1. the left mold 23-5 and the right mold 23-3 are separated, the samples are clamped in the circular cavity 23-2, and the lock catch 23-6 is closed to fasten the left mold 23-5 and the right mold 23-3.

It can be seen from FIG. 7 that the sampling mold 23 is composed of a left semicircular cavity 23-2 and a right semicircular cavity 23-2. The right mold 23-3 and the left mold 23-5 are connected through the hinge 23-4, and can be opened and closed by manually holding the handrails 23-1. The lock catch 23-6 achieves snap-fit by a round pin with a spring, which can ensure that the right mold 23-3 and the left mold 23-5 are closed in place during sampling. The sampling mold 23 is made of die steel.

The operator takes out the molten alloy or metal samples in the mixing furnace or holding furnace through the sampling mold 23 and performs preliminary chilling through a sampling quick chilling device. The chilled samples are marked by laser through the sample marking device.

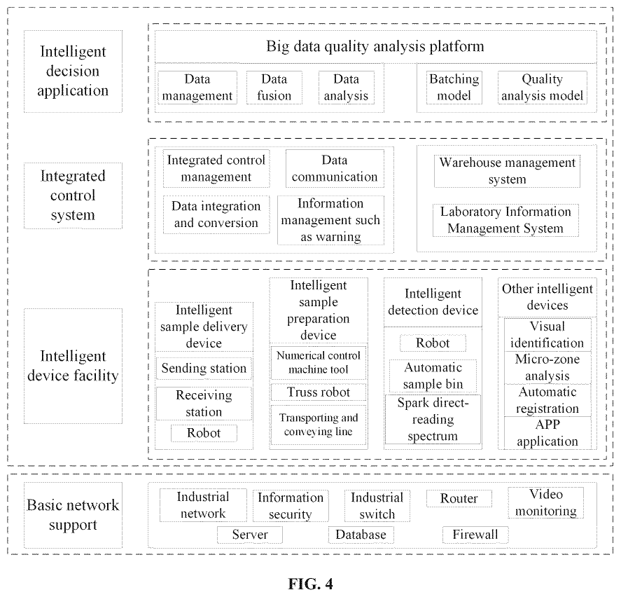

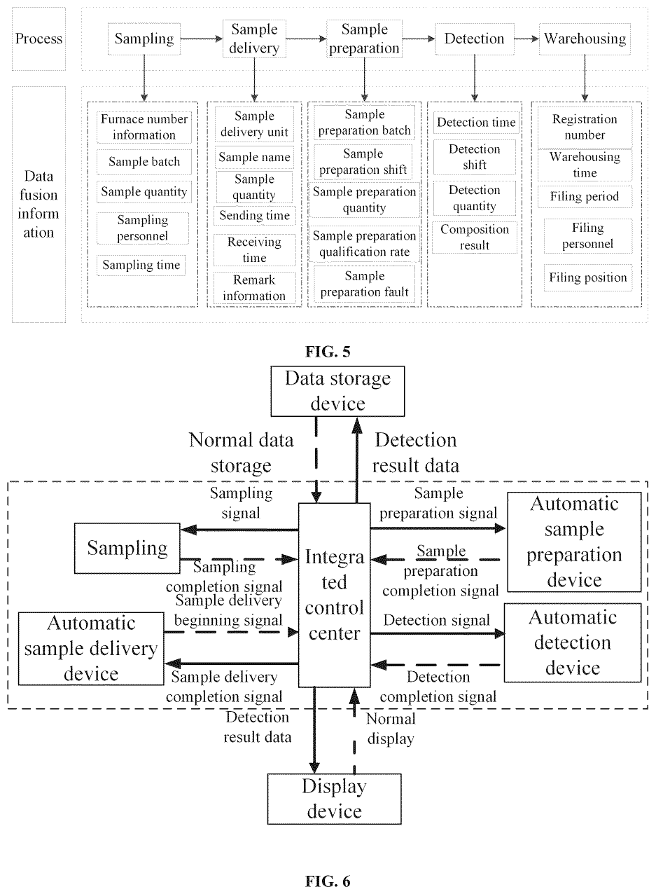

Referring to FIG. 5, the sampling information collected by the data fusion system includes furnace number information, sample batches, sample quantities, sampling personnels and sampling time.

### (2) Sample Delivery

The pneumatic sample conveying system conveys the samples to be detected from a sending end to a receiving end through compressed air, and completes long-distance conveying of the samples to be detected. The pneumatic sample conveying system includes a master station cabinet 2, a slave station cabinet 5, a pneumatic conveying pipeline 4, a sample conveying bin 3, an automatic sample bin opening and closing device 7, a vibration straightening device 8, a first industrial robot 6, a second industrial robot 9 and a first human-machine interaction unit.

One end of the pneumatic conveying pipeline 4 is connected with the master station cabinet 2, and the other end of the pneumatic conveying pipeline 4 is connected with the slave station cabinet 5. The sample conveying bin 3 is arranged on the pneumatic conveying pipeline 4. The automatic sample bin opening and closing device 7 is connected with the vibration straightening device 8. The sample conveying bin 3 is configured for loading the samples. The master station cabinet 2 is connected with the integrated control center, and the master station cabinet 2 is configured for sending a sample delivery begun signal when the sample conveying bin 3 loaded with the samples starts pneumatic conveying, to the integrated control center, and pneumatically conveying the sample conveying bin 3 loaded with the samples to the slave station cabinet 5 along the pneumatic conveying pipeline 4. The first industrial robot 6 transports the sample conveying bin 3 loaded with the samples to the automatic sample bin opening and closing device 7. The automatic sample bin opening and closing device 7 automatically opens the sample conveying bin 3 loaded with the samples, and the samples fall into the vibration straightening device 8. The vibration straightening device 8 adjusts the standing postures of the samples. The second industrial robot 9 further straightens the samples through a flexible gripper by utilizing a visual guiding device, and clamps and transports the samples to the automatic sample preparation system. The first human-machine interaction unit is connected with the data fusion system, and the first human-machine interaction unit enters the sample delivery information of the samples, and conveys the sample delivery information to the data fusion system.

Referring to FIG. 5, the sample delivery information collected by the data fusion system includes sample delivery units, sample names, sample quantities, sending time, receiving time and remark information.

The master station cabinet 2 and the slave station cabinet 5 both have the functions of sending the sample conveying bin 3 and receiving the sample conveying bin 3, and can record relevant information, such as times, quantities and numberings. The principle of pneumatic conveying is to generate pressure at both ends of the sample bin in a closed pipeline to push the sample bin. The whole pipeline conveying system is provided with a large gas storage station, the output pipeline of which is connected with the conveying pipeline, realizing air intake by controlling a valve switch by a solenoid valve.

When the sample bin arrives at the slave station cabinet 5, the slave station cabinet 5 system receives the sample bin and then feeds back to the master station cabinet 2 through wireless transmission. When the sample bin arrives at the slave station cabinet 5, a sensor senses this and sends a signal to the system, controlling the opening and closing device and the industrial robots by a programmable logic controller (PLC).

In an example, both the master station cabinet 2 and the slave station cabinet 5 are provided with a human-machine interaction control unit and a deceleration device which are controlled by the PLC. The human-machine interaction control unit is connected with the integrated control center to realize transmission of the sample delivery begun signal. The working principle of the deceleration device is to provide reverse airflow resistance to the moving sample conveying bin 3 to achieve deceleration.

FIG. 8 illustrates a specific structure of the sample conveying bin 3. The sample conveying bin 3 includes a rubber plug 3-1, a bin body 3-2 and a rubber cover 3-3. One end of the bin body 3-2 is arranged with the rubber plug 3-1, and the other end of the bin body 3-2 is arranged with the rubber cover 3-3. The bin body 3-2 is arranged with a plurality of circular mesh heat dissipation holes on its surface. The samples are loaded into the bin body 3-2 by opening the rubber cover 3-3. The sample conveying bin 3 is arranged with circular mesh heat dissipation holes with a diameter of 10 mm on its surface, which are distributed on the outer circumference of the cylinder body, to ensure that the sample conveying bin 3 is stressed evenly during rapid movement in the pipeline, also preventing the samples from being blocked in the conveying bin, and facilitating heat dissipation and cooling during the sample conveying process.

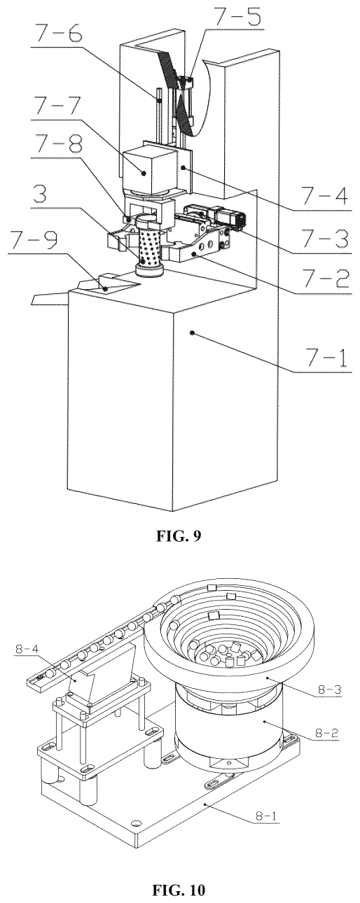

FIG. 9 illustrates a specific structure of the automatic sample bin opening and closing device 7. The automatic sample bin opening and closing device 7 includes a machine frame (the first machine frame 7-1), an electric turntable 7-3, a fixture (the first fixture 7-2), a support frame 7-4, an air cylinder (the first air cylinder 7-5), a sliding rail 7-6 and a cover opener 7-7. The electric turntable 7-3 is fixed on the machine frame, the fixture is installed on the electric turntable 7-3, and the fixture is configured for clamping the bin body 3-2 of the sample conveying bin 3. The sliding track 7-6 is installed on the machine frame, and one end of the sliding track 7-6 is connected with the air cylinder. The support frame 7-4 is arranged on the sliding track 7-6, and mounted with the cover opener 7-7 thereon. The air cylinder extends out to descend the support frame 7-4 to the rubber cover 3-3 of the sample conveying bin 3, and the cover opener 7-7 clamps the rubber cover 3-3 and rotates, and at the same time, the air cylinder moves upward to open the cover. The machine frame is arranged with a sliding groove 7-9 thereon, the electric turntable 7-3 rotates towards the direction of the sliding groove 7-9 to pour out the samples in the bin body 3-2, and the samples slide down to the vibration straightening device 8 through the sliding groove 7-9.

The work flow of the automatic sample bin opening and closing device 7 is as follows. The fixture clamps the sample conveying bin 3. The air cylinder extends out to descend the support frame 7-4 to the rubber cover 3-3. The cover opener 7-7 clamps the rubber cover 3-3 and rotates. At the same time, the air cylinder moves upward to open the cover. The electric turntable 7-3 rotates towards the direction of the sliding groove 7-9 to pour out the aluminum ingots in the sample conveying bin 3. The aluminum ingots slide to the vibration straightening device through the sliding groove 7-9 due to the sliding force of its own weight. The cover opener 7-7 is composed of a motor and a fixture (the second fixture 7-8), and the fixture clamps the motor to rotate to open and close the rubber cover 3-3.

FIG. 10 illustrates a specific structure of the vibration straightening device 8. The vibration straightening device 8 can arrange the samples according to relatively standard standing postures. The vibration straightening device 8 includes a machine frame (the second machine frame 8-1), a vibrating body 8-2, a vibrating bin 8-3, and a linear vibrator 8-4. The work flow is as follows. The aluminum ingots ascend orderly along the spiral track in the vibrating bin 8-3, and passes in order in a lying-down posture height restriction stop rods arranged on the ascending path. Ingots in standing posture fall in the vibrating bin 8-3 by the stop rods. After the aluminum ingots reach the top, the aluminum ingots are conveyed along the sliding groove 7-9 through a linear vibrator 8-4. When the aluminum ingots reaches their place, a proximity switch senses this and a vibration plate and the linear vibrator 8-4 suspend vibration. The working material rings of the vibration plate ascend orderly along the spiral track until the aluminum ingots are sent to a discharge port, realizing automatic material feeding to the next position. The linear vibrator 8-4 automatically and directionally sorts conveying material rings to the next position. The vibration straightening device ensures that the samples have relatively standard standing postures when being conveyed to corresponding stations, to facilitate the industrial robot gripper to clamp through visual guidance.

After marking, the samples are manually loaded into the sample conveying bin 3, and are pneumatically conveyed through the master station of the pneumatic sample conveying system via the pneumatic conveying pipeline 4. Relevant information such as sample numbers and batches is entered through the first human-machine interaction unit and gathered in a data fusion unit. After the sample conveying bin 3 reaches the slave station cabinet 5, a sample arrived signal is transmitted to the control system of the automatic sample bin opening and closing device 7 and the control unit of the industrial robot. The industrial robot firstly takes out the sample conveying bin 3 to transport it to the automatic sample bin opening and closing device 7. After the sample conveying bin 3 is clamped and fixed, a sample bin cover jig descends to clamp the rubber cover 3-3 and then rotates. After the cover is opened, the jig ascends, and the sample conveying bin 3 rotates by 180°. The samples to be detected fall into the vibration straightening device through the sliding groove 7-9 due to the gravity, and the second industrial robot 9 further straightens and clamps the samples (test samples) through the flexible gripper by using the visual guiding device to transport it to the sample tray 10 in the automatic sample preparation system.

### (3) Sample Preparation

The automatic sample preparation system mainly completes the operations, such as transportation and precision turn-milling of the aluminum alloy and aluminum ingot samples, and provides a detection and analysis end face with cleanliness and roughness meeting the requirements for testing and quality inspection.

The automatic sample preparation system includes a sample tray 10, a first sliding rail, a second sliding rail 13, a precision numerical control machine tool 12, a third industrial robot 11-1, an inductive switch and a second human-machine interaction unit. The sample tray 10 is arranged on one end of the first sliding rail, and the other end of the first sliding rail is connected with one end of the second sliding rail 13. The inductive switch is arranged at the other end of the second sliding rail 13. The sample tray 10 is configured for accommodating the samples and driving the samples to be conveyed from one end of the first sliding rail to the other end of the first sliding rail. After the sample tray 10 reaches the other end of the first sliding rail, the third industrial robot 11-1 clamps the samples from the sample tray 10 to the precision numerical control machine tool 12 for turn-milling, and putting the turn-milled samples back into the sample tray 10, where the precision numerical control machine tool 12 turn-mills the samples according to the sample preparation instruction from the integrated control center. The sample tray 10 receiving the turn-milled samples is conveyed from one end of the second sliding rail 13 to the other end of the second sliding rail 13, which triggers the inductive switch, and the inductive switch generates a sample in-place signal The signal output end of the inductive switch is connected with the integrated control center, and the inductive switch sends the sample in-place signal to the integrated control center. The second human-machine interaction unit is connected with the data fusion system, and the second human-machine interaction unit enters the sample preparation information of the samples, and transmits the sample preparation information to the data fusion system.

Referring to FIG. 5, the sample preparation information collected by the data fusion system includes sample preparation batches, sample preparation shifts, sample preparation quantities, sample preparation qualification rates and sample preparation faults.

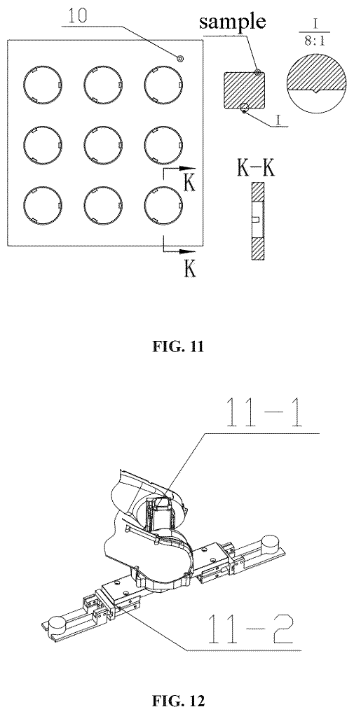

FIG. 11 illustrates a specific structure of the sample tray 10. The sample tray 10 is evenly distributed with through holes of the same shapes as the samples, and each through hole is evenly distributed with three bosses on its inner wall. The end face of the boss is 3-5 mm lower than that of the tray. The size of the boss shall support the sample stably, and the inner diameter of the through hole is the same as (or slightly larger than) the diameter of the sample. Since the samples are sampled by an opening and closing mold, protruding residues may remain at the bottom of the sample. The three bosses on the inner wall of the through hole on the tray can well avoid the protruding residues on the sample, so that the sample can be stably placed on the tray, recuding the clamping deviation when the robot grasps the samples, and finally avoiding the processing problems caused by clamping deviation. Also, it is able to avoid polluting the detection surface of the prepared samples, and ensure the accuracy of the detection result. I in FIG. 11 indicates a symbol representation for the pointed circle, and

$$\frac{I}{8 : 1}$$

illustrates the magnification at the position of I (an eightfold enlarged view).

FIG. 12 illustrates a specific structure of the third industrial robot 11-1. The sixth axis of the third industrial robot 11-1 is mounted with a connecting plate, which is equipped with two pneumatic gripping jaws 11-2, the opening and closing of which realizes grasping. The gripper 11 of the third industrial robot can rotate freely by 180°. The visual guiding device on the third industrial robot 11-1 can automatically judge the arrangement postures of samples, automatically identify the turn-milling surfaces and the marking surfaces of samples, and guide the third industrial robot 11-1 to grasp the samples.

The gripper 11 of the third industrial robot in the automatic sample preparation system clamps the samples from the sample tray for turn-milling. The gripping jaws at both ends of the gripper can complete 180° free rotation, and the feeding operation can be completed at the same time with unloading. The turn-milled samples are put into the original tray through the gripper 11 of the third industrial robot, and the sample tray can be transported to the automatic sample detection system through the sliding rail.

### (4) Detection

The automatic sample detection system includes a fourth industrial robot 14, a spark direct-reading spectrum analyzer 16 and a sample identity information identification system. The fourth industrial robot 14 is connected with the integrated control center, and the integrated control center sends a detection operation instruction to the fourth industrial robot 14 upon receiving the sample in-place signal. The fourth industrial robot 14 clamps the turn-milled samples to the detection station of the spark direct-reading spectrum analyzer 16 according to the detection operation instruction. The spark direct-reading spectrum analyzer 16 is respectively connected with the integrated control center and the data fusion system, and the spark direct-reading spectrum analyzer 16 detects the element composition of the turn-milled samples and sends the detection result to the integrated control center and the data fusion system. The integrated control center further sends a detection completion signal to the fourth industrial robot 14 upon receiving the detection result. The fourth industrial robot 14 further puts the detected samples back to the sample tray 10 according to the detection completion signal. The sample identity information identification system is connected with the data fusion system, and the sample identity information identification system enters the detection information of the samples and transmits the detection information to the data fusion system.

Referring to FIG. 5, the detection information collected by the data fusion system includes detection times, detection shifts, detection quantities and composition results.

The automatic sample detection system mainly completes the identification and entry of the identity information of the samples to be detected, loading, unloading and automatic detection and analysis, and the analysis data is sent to a furnace screen display device 22 and the data fusion system in real time.

The trigger electrode of the automatic sample detection system can automatically raise up and lower down and equip with force control components. The spark stand surface and internal tungsten needle electrodes of the sample identity information identification system are equipped with automatic flexible cleaning devices. According to the requirement of cleaning the spark stand and tungsten needle electrodes after each arc excitation, a rotary cleaning device is configured to clean the tungsten needle electrodes and remove the residual stains and dust on its surface. By configuring the flexible cleaning device, the surface of the spark table can be cleaned, and the dust generated by arc excitation on the table surface can be cleaned and collected at a designated position.

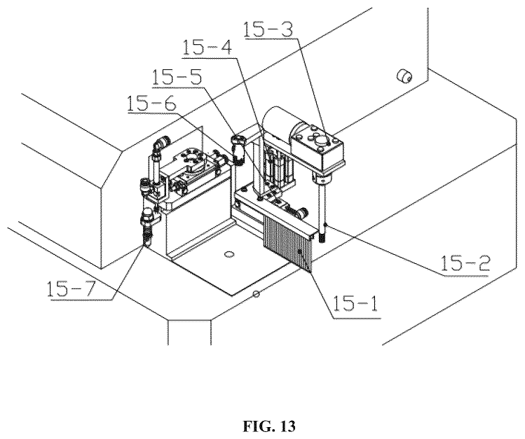

FIG. 13 illustrates the sample identity information identification, and a specific structure of a spark stand surface and internal electrode cleaning device. The device includes a scrubbing brush 15-1, a pen-shape brush 15-2, a motor 15-3, an air cylinder (the second air cylinder 15-4). a swing angle air cylinder 15-5, an information identification device 15-6 and an electric spark presser mechanism 15-7.

Upon receiving the sample in-place signal and the detection operation instruction, the controller of the fourth industrial robot 14 in the automatic sample detection system clamps the prepared samples and places it on the spark stand of the spark direct-reading spectrometer to start automatic identification of identity information of the entered sample and detect it, and upon completion of each detection, the fourth industrial robot 14 moves the sample position, a single sample arousing three positions, and the three detection results are averaged. Upon completion of each detection of sample, the spark stand surface and internal electrode cleaning device 15 starts cleaning the tungsten needle electrodes inside the spark stand and the surface of the spark stand

The quantity of the aluminum ingots loaded in each sample tray 10 is unchanged each time, and whether the detection of samples in the sample tray 10 is completed can be determined by counting.

### (5) Filing and Warehousing

The sample filing and warehousing system mainly completes automatic transporting, filing and warehousing of the detected samples, which is beneficial to sample re-inspection and quality tracing management. The sample filing and warehousing system includes a truss robot 18, a sample temporary storage device 20, a transport trolley in the form of an automated guided vehicle (AGV) 19, a third sliding rail, a fourth sliding rail, a sample bank, a sample storage cabinet and a third human-machine interaction unit. One end of the third sliding rail is connected with the other end of the second sliding rail 13, the other end of the third sliding rail is connected with one end of the fourth sliding rail, and the other end of the fourth sliding rail is connected with one end of the first sliding rail. The sample temporary storage device 20 is arranged on the AGV transport trolley 19. The sample tray 10 drives the detected samples to be conveyed from one end of the third sliding rail to the other end of the third sliding rail. The truss robot 18 carries the sample tray 10 to a sample temporary storage station, rotating by 180° to pour the detected samples into the sample temporary storage device 20, and then carries the empty sample tray 10 to the other end of the third sliding rail again. The empty sample tray 10 returns to the one end of the first sliding rail along the fourth sliding rail. The AGV transport trolley 19 transports the sample temporary storage device 20 loaded with the detected samples to the sample bank. In the sample bank the detected samples are loaded into the sample storage cabinets with corresponding date numbers. The third human-machine interaction unit is connected with the data fusion system, and the third human-machine interaction unit enters the warehousing information of the samples and transmits the warehousing information to the data fusion system.

The detected samples are moved into the sample tray through the fourth industrial robot 14 in the automatic sample detection system. The truss robot 18 moves and transports the sample tray to the sample temporary storage station, rotates by 180° to pour the detected samples into the sample temporary storage device 20. Then the AGV transport trolley 19 transports the samples to the sample bank. The samples are manually unloaded and loaded into the sample storage cabinets with corresponding date numbers. The detection result is fed back to a furnace man or the quality control department in time through a mobile digital assistant 21 and the screen display device.

The slave station cabinet 5 of the pneumatic conveying system, the automatic sample bin opening and closing device 7, the vibration straightening device 8 and the industrial robot, together with the automatic sample preparation system, the automatic sample detection system, the sample filing and warehousing system and the truss robot 18, are arranged in the same physical space to form a circular distribution pattern of assembly line operation.

Referring to FIG. 5, the warehousing information collected by the data fusion system includes registration numbers, warehousing times, archiving periods, archiving personnels and archiving locations.

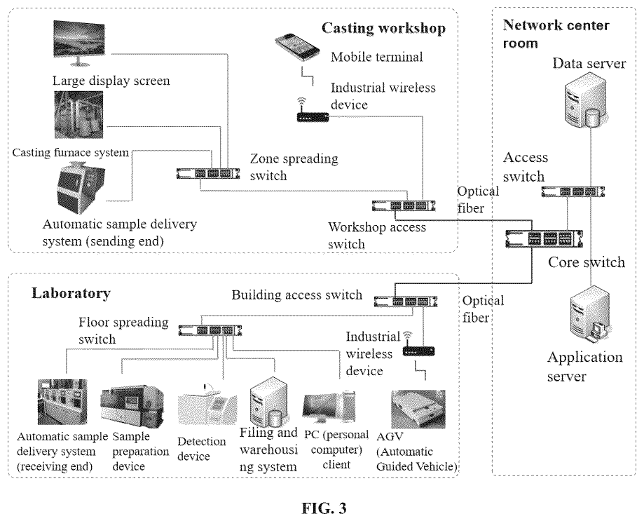

FIG. 3 illustrates an Internet-of-things topological graph according to the embodiments of the present disclosure. Different system devices are connected by mature Internet-of-things technology, including 4G, 5G wired and industrial Wifi wireless transmission networks, information data processing units, communication control units and data signal isolation units, to ensure effective interaction between wired networks and wireless networks.

FIG. 4 illustrates a system architecture. Under the premise of basic network support, for the intelligent equipment mainly equipped with are sample delivery, sample preparation, detection and other intelligent equipment. The centralized control system mainly completes data integration and conversion and centralized control management. Combined with FIG. 6 showing the control schematic of the embodiment, the whole-process centralized management and control system is arranged with a PLC control system unit. The unit modules of the PLC control system are deployed in a distributed control system mode (namely, centralized management and distributed control), including a pneumatic sample conveying control unit, an automatic sample preparation control unit, an automatic sample detection control unit, a sample archiving and warehousing control unit and a PLC control unit, the above modules operating independently and respectively deployed in respective business system. The unit modules transmits signals through designated protocols (TCP/IP, Modbus communication protocol, RS485 and the like) to form closed-loop control. Each system is arranged with a human-machine interaction unit with the characteristic of distributed centralized control, capable of performing functions such as local start-stop, state parameter adjustment and the like.

Specifically, as shown in FIG. 4 showing the system architecture of the embodiment, the data fusion unit is arranged at the system decision application level. Combined with FIG. 5 showing the data information fusion of the embodiment, the data fusion unit mainly fuses the key data of sampling, sample delivery, sample preparation, detection and warehousing procedures, laying a foundation for the construction of the quality model and intelligent control. A model bank includes an aluminum alloy proportioning model, an aluminum ingot proportioning model, a composition quality analysis control model and a quality early warning control model. The data fusion system can effectively collect running status parameters and material flow information data of each system device, and effectively integrate, clean, manage and apply in a visual manner the collected data, providing data support for the whole-process centralized management and control. The data fusion system mainly includes a data fusion unit, an host computer server and a one-way gateway physical isolation system. The data fusion system includes a data acquisition module, a data management module and the model bank. The data acquisition module collects the running status parameters, operation instructions and sample information parameters of each distributed control unit in the procedures of sampling, sample delivery, sample preparation, detection, filing and warehousing. The specific method is as follows. A multi-source heterogeneous data keyword table is established according to different data sources, and a standard format is preset for the acquired data according to actual requirements. According to the preset standard format, the data management module cleans the collected data by means of missing value cleaning, format content cleaning and logic cleaning, and filters redundant information. And, the data management module classifies the keyword table, and hierarchically matches and classifies the processed data with the classified keyword table according to attributes and uses, and after classification, transmits the data information to the model bank. The model in the model bank is based on the fundamentals of process knowledge theory, and adopts one of machine learning algorithms including back propagation artificial neural network (BP-ANN), support vector machine (SVM) and convolution neural network (CNN) to construct the aluminum alloy proportioning model, the aluminum ingot proportioning model and the composition quality analysis control model, and presets a threshold of each parameter in the production process according to the enterprise production standard, compares the output data of the data management module with the threshold of the parameter to judge whether the collected data is abnormal, and alerts the user through an early warning module if the collected data is abnormal, thus constructing a quality early warning control model. The mobile digital assistant 21 includes an information entry module, a data sending and receiving module and an APP application management.

The input data of the aluminum alloy proportioning model/aluminum ingot proportioning model refers to the composition data of existing alloy/aluminum ingots in a casting furnace. The output data of the aluminum alloy proportioning model/aluminum ingot proportioning model refers to the types of ingredient(s) and the amount of each ingredient still required to meet the requirements of aluminum alloy production, The on-site production of the aluminum alloy/aluminum ingots is guided through the output data.

The input data of the composition quality analysis control model refers to the content of each component of the produced products. The output data of the composition quality analysis control model refers to the suggestions on whether the product is qualified, which components in the product deviate from the target product, whether the obtained product can be delivered, whether the product needs to be recycled and recast. The on-site quality control of the product is guided through the output data.

The display device includes a mobile digital assistant 21 and a screen display device 22. The mobile digital assistant 21 mainly includes an information entry module, a data sending and receiving module and an APP application program, and has a series of functions such as single sign-on. APP management and operation, video recording, data sending and receiving, and two-dimensional code identification. The mobile digital assistant 21 is mainly configured for receiving quality inspection and test result data, prompting quality abnormality alarm and pushing KPI quality reports.

The whole work flow of the integrated equipment for whole-process automatic quality inspection and testing of aluminum alloy and aluminum ingots is as follows. An operator takes out molten alloy or metal samples in a mixing furnace or a holding furnace through a sampling mold 23, carries out preliminary chilling through a sampling quick chilling system, and carries out identity attribute marking through a sample marking system after chilling. The marked samples are manually loaded into the sample conveying bin 3, and pneumatically conveyed through the master station cabinet 2 of the pneumatic sample conveying system via the conveying pipeline. The sample numbers, batches and other related information are input through the human-machine interaction unit. After the sample conveying bin 3 reaches the slave station cabinet 5, the sample arrived signal is transmitted to the control system of the automatic sample bin opening and closing device 7 and the industrial robot 6. The robot firstly takes out the sample bin to transport it to the automatic sample bin opening and closing device 7. After the cover of the sample bin is opened, the sample bin automatically rotates by 180°. The samples to be detected fall into the vibration straightening device 8 due to the gravity, and the standing postures of the samples to be detected are adjusted by the vibration straightening device. The industrial robot 9 further straightens the samples through the flexible gripper by utilizing the visual guiding device, and clamps and transports the samples to the sample tray 10 of the automatic sample preparation system. The industrial robot 11 in the automatic sample preparation system clamps the samples for turn-milling. With the gripping jaws at both ends of the gripper and 180° Free rotation, unloading can be completed while performing uploading. The turn-milled samples are put into the original tray through the robot, and the sample tray can be transported to the automatic identification and detection system through the sliding rail 13. Upon receiving the sample in-place signal and the detection operation instruction, the industrial robot 14 in the automatic sample identification and detection system clamps the prepared sample for sample identity information identification and entry, and places it on the spark stand 15 for automatic detection. Each time the detection is completed, a mechanical hand moves the sample position, a single sample arousing three positions, and the three detection results are averaged. The detected samples are put into the original tray. After all the samples in the tray are detected, the truss robot 18 transports the sample tray 10 to the sample temporary storage station, and rotates the sample tray 10 by 180° to pour the samples into the sample temporary storage device 20. The sample tray 10 returns to the original position again and is transported to the automatic sample preparation station through the sliding rail. The sample temporary storage device 20 is transported to the sample bank by the AGV transport trolley 19, and the samples are manually unloaded and loaded into sample storage cabinets with corresponding date numbers. The test result is fed back to the furnace man or the quality control department in time through the screen display device and the mobile digital assistant 21.

According to the present disclosure, a complete set of integrated equipment and a centralized management and control system is established, a running method and working steps of the system are created, and the whole-process intelligent quality inspection and testing of aluminum alloy and aluminum ingots can be quickly and conveniently completed through integration of various systems. Compared with the traditional technology and production status, through the integrated layout, the floor area can be effectively reduced, and the investment cost of quality inspection and testing is reduced. Through the integrated operation of the whole-process automation equipment, the labor intensity of workers can be significantly reduced, and the occupational health hazards and operational safety accidents can be reduced. Through data fusion and model building, the information management level can be comprehensively improved, and the intelligent management of production can be realized.

All embodiments in this specification are described in a progressive manner. Each embodiment focuses on differences from other embodiments. For the part that is the same or similar between different embodiments, reference may be made between the embodiments.

Several examples are used for illustration of the principles and implementation methods of the present disclosure. The description of the embodiments is used to help understand the method and the core principles of the present disclosure. Those skilled in the art can make various modifications in terms of specific embodiments and scope of application in accordance with the teachings of the present disclosure. In conclusion, the content of this specification shall not be construed as a limitation to the present disclosure.

What is claimed is:

1. An intelligent integrated equipment for a whole process of quality inspection and testing of aluminum alloy and aluminum ingots, comprising a pneumatic sample conveying system, an automatic sample preparation system, an automatic sample detection system, a sample filing and warehousing system, an integrated control center, a display device and a data fusion system;
wherein the integrated control center is connected with the automatic sample preparation system, the automatic sample detection system and the display device; the data fusion system is connected with the pneumatic sample conveying system, the automatic sample preparation system, the automatic sample detection system and the sample filing and warehousing system;
the pneumatic sample conveying system is configured for pneumatically conveying samples taken out from a mixing furnace or a holding furnace to the automatic sample preparation system;
the automatic sample preparation system is configured for turn-milling the samples according to a sample preparation instruction from the integrated control center, and conveying turn-milled samples to the automatic sample detection system; the turn-milled samples are aluminum alloys or aluminum ingots to be detected;
the automatic sample detection system is configured for detecting element composition of the turn-milled samples according to a detection instruction from the integrated control center, sending a detection result to the integrated control center, and conveying detected samples to the sample filing and warehousing system for filing and warehousing;
the integrated control center is configured for sending detection results to the display device for display;
the data fusion system is configured for collecting sampling information, sample delivery information of the pneumatic sample conveying system, preparation information of the automatic sample preparation system, detection information of the automatic sample detection system and warehousing information of the sample filing and warehousing system, and obtaining a proportioning adjustment scheme according to the sampling information, the sample delivery information, the preparation information, the detection information and the warehousing information by using an aluminum alloy proportioning model and an aluminum ingot proportioning model, and analyzing product quality by using a composition quality analysis control model.

2. The intelligent integrated equipment for a whole process of quality inspection and testing of aluminum alloy and aluminum ingots according to claim 1, further comprising a sampling mold, a pneumatic quick chilling device and a sample marking device;
wherein the sampling mold is configured for taking out molten alloy samples or molten metal samples in the mixing furnace or the holding furnace according to a sampling instruction from the integrated control center;
the pneumatic quick chilling device is configured for chilling the molten alloy samples or molten metal samples; and
the sample marking device is configured for marking the identity properties of the chilled samples.

3. The intelligent integrated equipment for a whole process of quality inspection and testing of aluminum alloy and aluminum ingots according to claim 1, wherein the pneumatic sample conveying system comprises a master station cabinet, a slave station cabinet, a pneumatic conveying pipeline, a sample conveying bin, an automatic sample bin opening and closing device, a vibration straightening device, a first industrial robot, a second industrial robot and a first human-machine interaction unit;
one end of the pneumatic conveying pipeline is connected with the master station cabinet, and an other end of the pneumatic conveying pipeline is connected with the slave station cabinet;
the sample conveying bin is arranged on the pneumatic conveying pipeline; the automatic sample bin opening and closing device is connected with the vibration straightening device;
the sample conveying bin is configured for loading the samples;
the master station cabinet is connected with the integrated control center, and the master station cabinet is configured for sending a sample delivery begun signal when the sample conveying bin loaded with the samples starts pneumatic conveying, to the integrated control center, and pneumatically conveying the sample conveying bin loaded with the samples to the slave station cabinet along the pneumatic conveying pipeline;
the first industrial robot is configured for transporting the sample conveying bin loaded with the samples to the automatic sample bin opening and closing device;
the automatic sample bin opening and closing device is configured for automatically opening the sample conveying bin loaded with the samples, enabling the samples to fall into the vibration straightening device;
the vibration straightening device is configured for adjusting standing posture of the samples;
the second industrial robot is configured for further straightening the samples through a flexible gripper by utilizing a visual guiding device, and clamping and transporting the samples to the automatic sample preparation system; and
the first human-machine interaction unit is connected with the data fusion system, and the first human-machine interaction unit is configured for entering the sample delivery information of the samples, and transmitting the sample delivery information to the data fusion system.

4. The intelligent integrated equipment for a whole process of quality inspection and testing of aluminum alloy and aluminum ingots according to claim 1, wherein the automatic sample preparation system comprises a sample tray, a first sliding rail, a second sliding rail, a precision numerical control machine tool, a third industrial robot, an inductive switch and a second human-machine interaction unit;
the sample tray is arranged on one end of the first sliding rail, and an other end of the first sliding rail is connected with one end of the second sliding rail; the inductive switch is arranged at an other end of the second sliding rail;
the sample tray is configured for accommodating the samples and driving the samples to be conveyed from the one end of the first sliding rail to the other end of the first sliding rail;
the third industrial robot is configured for clamping the samples from the sample tray to the precision numerical control machine tool for turn-milling after the sample tray reaches the other end of the first sliding rail, and putting the turn-milled samples back into the sample tray;
wherein, the precision numerical control machine tool turn-mills the samples according to the sample preparation instruction from the integrated control center;
the sample tray receiving turn-milled samples is conveyed from the one end of the second sliding rail to the other end of the second sliding rail to trigger the inductive switch, and the inductive switch generates a sample in-place signal;
a signal output end of the inductive switch is connected with the integrated control center, and the inductive switch is configured for sending the sample in-place signal to the integrated control center; and
the second human-machine interaction unit is connected with the data fusion system, and the second human-machine interaction unit is configured for entering sample preparation information of the samples, and transmitting the sample preparation information to the data fusion system.

5. The intelligent integrated equipment for a whole process of quality inspection and testing of aluminum alloy and aluminum ingots according to claim 4, wherein the automatic sample detection system comprises a fourth industrial robot, a spark direct-reading spectrum analyzer and a sample identity information identification system;
the fourth industrial robot is connected with the integrated control center, and the integrated control center is configured for sending a detection operation instruction to the fourth industrial robot upon receiving the sample in-place signal; the fourth industrial robot is configured for clamping the turn-milled samples to a detection station of the spark direct-reading spectrum analyzer according to the detection operation instruction;
the spark direct-reading spectrum analyzer is respectively connected with the integrated control center and the data fusion system, and the spark direct-reading spectrum analyzer is configured for detecting element composition of the turn-milled samples and sending a detection result to the integrated control center and the data fusion system;
the integrated control center is also configured for sending a detection completion signal to the fourth industrial robot upon receiving the detection result;
the fourth industrial robot is also configured for putting the detected samples back onto the sample tray according to the detection completion signal; and
the sample identity information identification system is connected with the data fusion system, and the sample identity information identification system is configured for entering the detection information of the samples and transmitting the detection information to the data fusion system.

6. The intelligent integrated equipment for a whole process of quality inspection and testing of aluminum alloy and aluminum ingots according to claim 4, wherein the sample filing and warehousing system comprises a truss robot, a sample temporary storage device, an automated guided vehicle (AGV) transport trolley, a third sliding rail, a fourth sliding rail, a sample bank, a sample storage cabinet and a third human-machine interaction unit;
one end of the third sliding rail is connected with the other end of the second sliding rail, an other end of the third sliding rail is connected with one end of the fourth sliding rail, and an other end of the fourth sliding rail is connected with the one end of the first sliding rail; the sample temporary storage device is arranged on the AGV transport trolley.
the sample tray is configured for driving the detected samples to be conveyed from one end of the third sliding rail to the other end of the third sliding rail;
the truss robot is configured for transporting the sample tray to a sample temporary storage station, rotating by 180° to pour the detected samples into the sample temporary storage device, and then transporting the empty sample tray to the other end of the third sliding rail again; the empty sample tray returns to the one end of the first sliding rail along the fourth sliding rail;
the AGV transport trolley is configured for transporting the sample temporary storage device loaded with the detected samples to the sample bank; in the sample bank the detected samples are loaded into the sample storage cabinets with corresponding date numbers; and
the third human-machine interaction unit is connected with the data fusion system, and the third human-machine interaction unit is configured for entering the warehousing information of the samples and transmitting the warehousing information to the data fusion system.

7. The intelligent integrated equipment for a whole process of quality inspection and testing of aluminum alloy and aluminum ingots according to claim 4, wherein the sample tray is evenly distributed with a plurality of through holes, each through hole is evenly arranged with three bosses, an end face of the boss is lower than that of the sample tray, and the three bosses are configured for supporting the samples;
a gripper of the third industrial robot is equipped with two pneumatic gripping jaws, and the gripper is capable of rotating freely by 180° and grasping the samples through opening and closing of the two pneumatic gripping jaws.

8. The intelligent integrated equipment for a whole process of quality inspection and testing of aluminum alloy and aluminum ingots according to claim 3, wherein the sample conveying bin comprises a rubber plug, a bin body and a rubber cover;
one end of the bin body is arranged with the rubber plug, the other end of the bin body is arranged with the rubber cover; and a surface of the bin body is arranged with a plurality of circular mesh heat dissipation holes; and
the samples are loaded into the bin body by opening the rubber cover.

9. The intelligent integrated equipment for a whole process of quality inspection and testing of aluminum alloy and aluminum ingots according to claim 8, wherein the automatic sample bin opening and closing device comprises a machine frame, an electric turntable, a fixture, a support frame, an air cylinder, a sliding rail and a cover opener;
the electric turntable is fixed on the machine frame, the fixture is installed on the electric turntable, and the fixture is configured for clamping the bin body of the sample conveying bin;
the sliding rail is installed on the machine frame, and one end of the sliding rail is connected with the air cylinder; the support frame is arranged on the sliding rail, and the support frame is mounted with the cover opener; cover opening is achievable by the air cylinder extending out to descend the support frame to the rubber cover of the sample conveying bin, and the cover opener clamping the rubber cover and rotating, meanwhile the air cylinder moving upward; and
the machine frame is arranged with a sliding groove, the electric turntable rotates towards the direction of the sliding groove to pour out the samples into the bin body, and the samples slide down to the vibration straightening device through the sliding groove.

10. The intelligent integrated equipment for a whole process of quality inspection and testing of aluminum alloy and aluminum ingots according to claim 2, wherein the sampling mold comprises a left mold, a right mold, a hinge, a lock catch and two handrails;
one end of the left mold and one end of the right mold are connected through the hinge, and the other end of the left mold and the other end of the right mold are connected through the lock catch;
a side of the left mold and a side of the right mold connecting to each other are each arranged with a semicircular groove, and the two semicircular grooves form a circular cavity; an other side of the left mold and an other side of the right mode are each arranged with a handrail; and
clamping samples from the mixing furnace or holding furnace is accomplishable by opening the lock catch through the handrails, separating the left mold and the right mold, clamping the samples in the circular cavity, and closing the lock catch to fasten the left mold and the right mold.
